(19) United States
(12) Patent Application Publication
(10) Pub. No.: US 2025/0180901 A1
(43) Pub. Date: Jun. 5, 2025

(54) OPTICAL WAVEGUIDE SYSTEM AND AUGMENTED REALITY DEVICE

(71) Applicant: GOERTEK OPTICAL TECHNOLOGY CO., LTD, Weifang, Shandong (CN)

(72) Inventors: En ZHAO, Weifang, Shandong (CN); Yi RAO, Weifang, Shandong (CN); Xiao WU, Weifang, Shandong (CN)

(21) Appl. No.: 18/837,728

(22) PCT Filed: Jun. 22, 2022
(86) PCT No.: PCT/CN2022/100308

§ 371 Date: Aug. 12, 2024

(30) Foreign Application Priority Data
Mar. 29, 2022 (CN) 202210320744.6

(51) Int. Cl. G02B 27/01

(52) U.S. Cl. CPC G02B 27/0101

(57) ABSTRACT

An optical waveguide system and an augmented reality device are disclosed. The optical waveguide system comprises an optical waveguide and a grating disposed on a surface of the optical waveguide, the grating comprises a plurality of cell arrays each having a parallelogram shape, such that one incident light beam incident on the grating is diffracted into two diffracted light beams, and angle between components of one diffracted light beam and the other diffracted light beam on a plane of the grating and a component of the incident light beam on the plane of the grating are not equal. The optical waveguide system including the grating can be combined in more flexible forms, for improving the lighting efficiency, reducing and maintaining a smaller volume of the waveguide lens etc., and the appearance of the waveguide system can also be changed more freely, to meet the preferences of different consumers.

### TECHNICAL FIELD

The present disclosure relates to a technical field of augmented reality devices, and in particular to an optical waveguide system and an augmented reality device.

### BACKGROUND

Existing optical waveguides based on two-dimensional gratings generally use a special method, that is, an angle between a diffracted beam and an incident beam is the same. This pupil expansion method limits the application of the two-dimensional gratings. Besides, the areas or the volumes of the optical waveguides based on one-dimensional gratings are relatively large. This type of product looks more like a helmet, also known as a head-mounted display (HMD) system. The relatively bulky head-mounted solution limits the further application of large-field-of-view AR optical waveguides, especially in the consumer-scale market.

In view of this, it is necessary to provide a new optical waveguide system and an augmented reality device to solve or at least alleviate the above technical defects.

### SUMMARY

A main objective of the present disclosure is to provide an optical waveguide system and an augmented reality device, aiming to solve the technical problem of the single application form of the optical waveguide system in the related art.

To achieve the above objective, according to one aspect of the present disclosure, the present disclosure provides an optical waveguide system, comprising: an optical waveguide; and a grating disposed on a surface of the optical waveguide, wherein the grating comprises a plurality of cell arrays, and each of the cell arrays has a parallelogram shape, such that one incident light beam incident on the grating is diffracted into two diffracted light beams, and an angle between a component of one diffracted light beam on a plane of the grating and a component of the incident light beam on the plane of the grating is not equal to an angle between a component of the other diffracted light beam on the plane of the grating and the component of the incident light beam on the plane of the grating.

In one embodiment, each of the cell arrays comprises a first grating vector and a second grating vector, the parallelogram shape comprises adjacent horizontal sides and vertical sides, the first grating vector corresponds to the horizontal sides, and the second grating vector corresponds to the vertical sides.

In one embodiment, an angle between the first grating vector and the second grating vector is θ, and 0<θ<180°, and lengths of the horizontal sides are not equal to lengths of the vertical sides.

In one embodiment, the grating is a two-dimensional grating, and each of the cell arrays comprise at least four lattice points, wherein each of the lattice points has the same height, or at least two of the lattice points have different heights, and wherein when each of the lattice points of each of the cell arrays has the same height, the lattice points of at least two of the cell arrays have different heights.

In one embodiment, each of the lattice points has the same rotation angle, or at least two of the lattice points have different rotation angles, and wherein when each of the lattice points of each of the cell arrays has the same rotation angle, the lattice points of at least two of the cell arrays have different rotation angle.

In one embodiment, each of the lattice points has the same twisting angle, or at least two of the lattice points have different twisting angles, and wherein when each of the lattice points of each of the cell arrays has the same twisting angle, the lattice points of at least two of the cell arrays have different twisting angles.

In one embodiment, the grating comprises an in-coupling grating and an out-coupling grating, and the in-coupling grating and the out-coupling grating are disposed asymmetrically.

In one embodiment, the in-coupling grating is disposed to be translated by a preset distance relative to a horizontal symmetry axis or a vertical symmetry axis of the out-coupling grating.

In one embodiment, the in-coupling grating and the out-coupling grating are synchronously rotated by the same angle.

In one embodiment, the in-coupling grating is disposed to be rotated relative to the out-coupling grating by a first angle; or the out-coupling grating is disposed to be rotated relative to the in-coupling grating by a second angle.

In one embodiment, the optical waveguide comprises a first optical waveguide, a second optical waveguide and a third optical waveguide stacked in sequence, and the grating comprises a first layer of grating disposed on a surface of the first optical waveguide, a second layer of grating disposed on a surface of the second optical waveguide and a third layer of grating disposed on a surface of the third optical waveguide.

In one embodiment, the first layer of grating comprises a first in-coupling grating and a first out-coupling grating, the second layer of grating comprises a second in-coupling grating and a second out-coupling grating, the third layer of grating comprises a third in-coupling grating and a third out-coupling grating, and when viewed in a stacking direction of the first optical waveguide, the second optical waveguide and the third optical waveguide, the first in-coupling grating, the second in-coupling grating and the third in-coupling grating are mutually staggered.

In one embodiment, the first optical waveguide is a red-light waveguide, the second optical waveguide is a green-light waveguide, and the third optical waveguide is a blue-light waveguide.

In one embodiment, the optical waveguide comprises a first optical waveguide and a second optical waveguide stacked in sequence, and the grating comprises a first layer of grating disposed on a surface of the first optical waveguide and a second layer of grating disposed on a surface of the second optical waveguide, wherein the first layer of grating comprises a first in-coupling grating and a first out-coupling grating, the second layer of grating comprises a second in-coupling grating and a second out-coupling grating, and when viewed in a stacking direction of the first optical waveguide and the second optical waveguide, the first in-coupling grating and the second in-coupling grating are mutually staggered, and wherein the first optical waveguide transmits one of three color lights of red light, green light and blue light, and the second optical waveguide transmits the other two color lights except the color light transmitted by the first optical waveguide.

In one embodiment, the augmented reality device comprises the optical waveguide system as described above.

In the above solutions, the optical waveguide system comprises an optical waveguide and a grating disposed on a surface of the optical waveguide, the grating comprises a plurality of cell arrays, and each of the cell arrays has a parallelogram shape, such that one incident light beam incident on the grating is diffracted into two diffracted light beams, and an angle between a component of one diffracted light beam on a plane of the grating and a component of the incident light beam on the plane of the grating is not equal to an angle between a component of the other diffracted light beam on the plane of the grating and the component of the incident light beam on the plane of the grating. By using a two-dimensional grating composed of the cell arrays with parallelogram shapes, after one incident light beam is incident on the grating from the optical waveguide, two diffracted light beam are generated, the angles formed by components of the two diffracted light beams on the plane of the grating are not equal to each other. Such a diffraction means enables the optical waveguide system including the grating to be combined in more flexible form, and these forms may improve many effects compared with the existing optical waveguide system, including but not limited to improving the light efficiency, reducing and maintaining a smaller volume of the waveguide lens, etc., and the appearance of the waveguide system can also be changed more freely, to meet the preferences of different consumers.

### BRIEF DESCRIPTION OF DRAWINGS

In order to more clearly illustrate the technical solutions in the embodiments of the present disclosure or in the related art, the drawings required for use in the description of the embodiments or the related art will be briefly introduced below. Obviously, the drawings described below are only some embodiments of the present disclosure. For those skilled in the art, other drawings can be obtained based on the structures shown in these drawings without paying any creative work.

FIG. 1 is a schematic diagram of a rectangular cell array A in the related art;

FIG. 2 is a schematic diagram of a parallelogram cell array (cell array B) according to an embodiment of the present disclosure;

FIG. 3 is a schematic diagram of light diffraction of an optical waveguide system composed of cell arrays A in the related art;

FIG. 4 is a schematic diagram of light diffraction of an optical waveguide system composed of parallelogram cell arrays (cell array B) according to an embodiment of the present disclosure;

FIG. 5 is a schematic diagram of four forms of lattice points of the cell array (cell array B) according to an embodiment of the present disclosure;

FIG. 6 is a schematic diagram of four relative positions of the in-coupling grating and the out-coupling grating of the grating according to the embodiment of the present disclosure;

FIG. 7 is a schematic diagram of the arrangement structure of a first layer of grating, a first optical waveguide, a second layer of grating, a second optical waveguide, a third layer of grating, and a third optical waveguide according to an embodiment of the present disclosure.

### DESCRIPTION OF REFERENCE NUMBERS

1. optical waveguide; 2. grating (grating B), 2.1. cell array (cell array B); 2.1.1. lattice point; 3. grating A; 3.1. cell array A; 4. incident light beam; 5. diffracted light beam; 6. in-coupling grating; 7. out-coupling grating; 8. first optical waveguide; 9. second optical waveguide; 10. third optical waveguide; 11. first in-coupling grating; 12. second in-coupling grating; 13. third in-coupling grating; 14. first out-coupling grating; 15. second out-coupling grating; 16. third out-coupling grating.

The achievement of purpose, characteristics and advantages of the present disclosure will be further explained in conjunction with the embodiments and with reference to the accompanying drawings.

### DETAILED DESCRIPTIONS

The following will be combined with the drawings in the embodiments of the present disclosure to clearly and completely describe the technical solutions in the embodiments of the present disclosure. Obviously, the described embodiments are only part of the embodiments of the present disclosure, not all of the embodiments. Based on the embodiments of the present disclosure, all other embodiments obtained by those skilled in the art without creative work are within the scope of protection of the present disclosure.

It should be noted that all directional indications (such as up, down, etc.) in the embodiments of the present disclosure are only used to explain the relative position relationship, movement status, etc. between the components in a certain specific posture (as shown in the drawings). If the specific posture changes, the directional indication will also change accordingly.

In addition, in the present disclosure, descriptions such as “first”, “second”, etc. are only used for descriptive purposes and cannot be understood as indicating or implying their relative importance or implicitly indicating the number of the indicated technical features. Therefore, the features defined as “first” and “second” may explicitly or implicitly comprise at least one of the features.

Furthermore, the technical solutions between the various embodiments of the present disclosure may be combined with each other, but this must be based on the fact that they can be implemented by those skilled in the art. When the combination of technical solutions is mutually contradictory or cannot be implemented, it should be deemed that such combination of technical solutions does not exist and is not within the scope of protection required by the present disclosure.

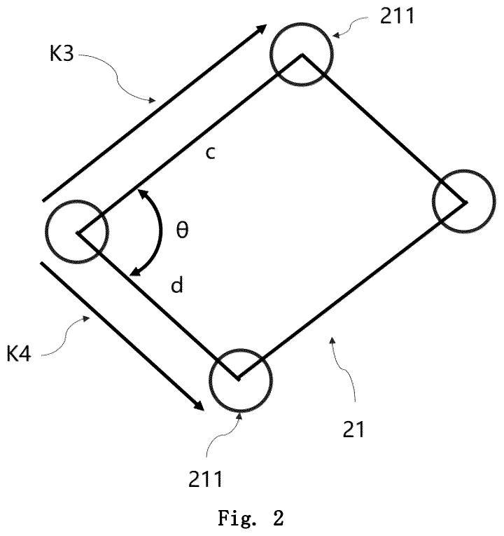

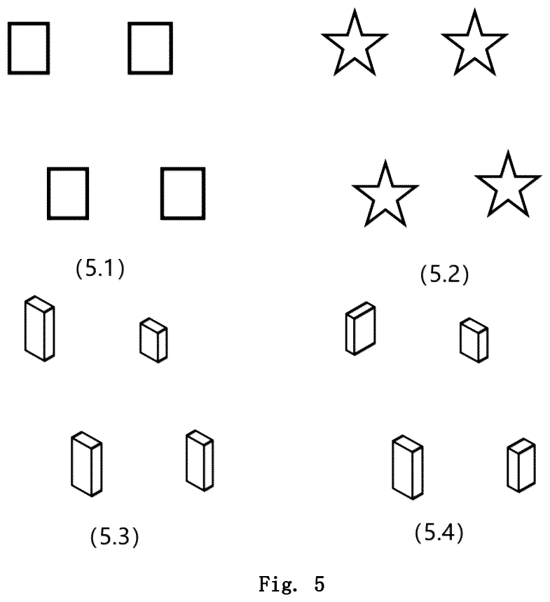

Referring to FIG. 2 and FIG. 4, according to one aspect of the present disclosure, the present disclosure provides an optical waveguide system, including an optical waveguide 1 and a grating 2 disposed on a surface of the optical waveguide 1, wherein the grating 2 comprises a plurality of cell arrays 21, and each of the cell arrays 21 has a parallelogram shape, such that one incident light beam 4 incident on the grating 2 is diffracted into two diffracted light beams 5, and an angle between a component of one diffracted light beam 5 on a plane of the grating and a component of the incident light beam 4 on the plane of the grating 2 is not equal to an angle between a component of the other diffracted light beam 5 on the plane of the grating and the component of the incident light beam 4 on the plane of the grating 2.

In the above embodiment, by using the gratings 2, specifically two-dimensional gratings, composed of the cell arrays 21 with parallelogram shapes, after one incident light beam 4 is incident on the grating 2 from the optical waveguide 1, two diffracted light beam are formed, the angles formed by the components of the two diffracted light beams 5 on the plane of the grating 2 are not equal to each other. Such a diffraction means enables the optical waveguide system including the grating 2 to be combined in a freer form, and these forms may improve many effects compared with the existing optical waveguide system, including but not limited to improving the light efficiency, reducing and maintaining a smaller volume of the waveguide lens, etc., and the appearance of the waveguide system can also be changed more freely, to meet the preferences of different consumers.

In one embodiment, each of the cell arrays 21 comprises a first grating vector and a second grating vector, the parallelogram shape comprises adjacent horizontal sides and vertical sides, the first grating vector corresponds to the horizontal sides, and the second grating vector corresponds to the vertical sides. The corresponding here may refer to being overlapped in some cases. In one embodiment, the angle between the first grating vector and the second grating vector is θ, and 0<θ<180°, the length of each of the horizontal sides is not equal to the length of each of the vertical sides, and the lengths of the first grating vector and the second grating vector are also not equal to each other.

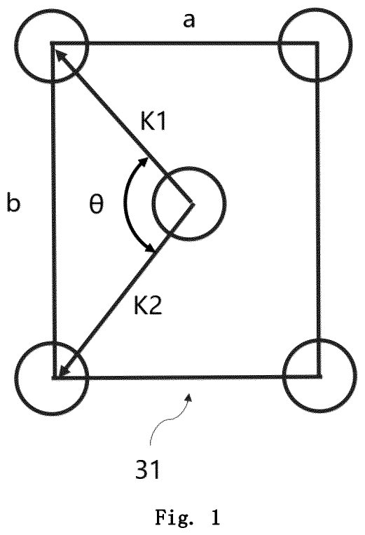

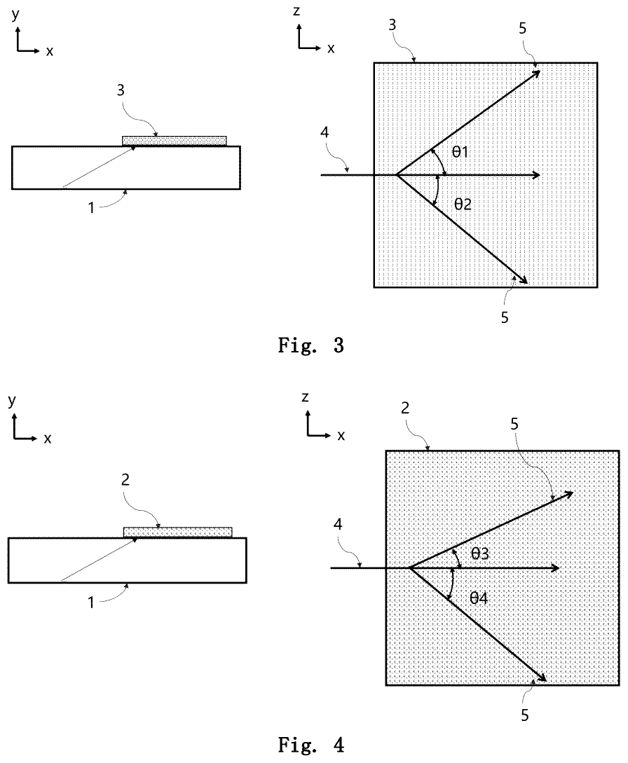

It should be noted that in the related art, the grating A3 uses a cell array A31 shown in FIG. 1, the lattice points of the cell array A31 are distributed in a rectangular shape and the center of the rectangle is also a lattice point, the two grating vectors are equal to each other, and the two grating vectors are represented by K1 and K2, that is, K1=K2, and the side a May be equal to the side b, or a may not be equal to the side b, or may be K1=K2=a=b, the angle between the side a and the side b is 90°, and the angle θ between the two grating vectors may be any angle greater than 0° and less than 180°. The cell arrays A31 are translated along the side a or the side b by a distance of a or b, and repeated this process continuously to obtain the grating A3. Referring to FIG. 3, in the grating A3 made of the cell arrays A31 and an optical waveguide system composed of the grating A3 made of the cell arrays A31 and an optical waveguide 1, the refractive index of the optical waveguide 1 is usually between 1.5 and 2.5, and light is propagated in the optical waveguide 1 in the form of total reflection. When the light propagates and hits the grating A3, it is diffracted in a specific diffraction form, and the form of diffraction depends on the structure of the grating A3. The sides a and b of the cell array A31 may be parallel to the sides of the grating A3, respectively, or the sides a and b of the cell array A and the sides of the grating A3 may have a certain angle and be twisted. When the component of the incident light on the plane of the grating A3 is perpendicular to the side a or the side b of the cell array A31, there are two diffracted light beams 5 of the incident light beam 4, and an angle between one diffracted light beam 5 and the incident light beam 4 is equal to an angle between the other diffracted light beam 5 and the incident light beam 4, that is, θ1=θ2, and the components of the two diffracted light beams 5 in the plane of the grating A3 are equal to each other.

In the above embodiment of the present disclosure, the grating 2 (in order to distinguishing it from the grating A3 in the related art, it may also be called as a grating B2) adopts the cell arrays 21 shown in FIG. 2 (in order to distinguishing from the cell arrays A31 in the related art, they can also be called as a cell array B21), the first grating vector is represented by K3, the second grating vector is represented by K4, the cell array 21 has a parallelogram shape, and the two grating vectors contained therein may be unequal to each other, that is, K3 is not equal to K4, and K3 coincides with the side c, K4 coincides with the side d, the side c and the side d are usually unequal to each other, and the angle θ may be any angle greater than 0° and less than 180°. The cell arrays 21 are translated along the side c or the side d by a distance of c or d, and repeated this process continuously to obtain the grating 2. Referring to FIG. 4, in the grating 2 made of the cell arrays 21 and an optical waveguide system composed of the grating 2 made of the cell arrays 21 and an optical waveguide 1, the refractive index of the optical waveguide 1 is also between 1.5 and 2.5, and light is propagated in the optical waveguide 1 in the form of total reflection. When the light propagates and hits the grating 2, it is diffracted in a specific diffraction form, and the form of diffraction depends on the structure of the grating 2. The sides c and d of the cell array 21 may be parallel to the sides of the grating 2, respectively, or the sides c and d of the cell array 21 and the sides of the grating 2 may have a certain angle and be twisted. When the component of the incident light on the plane of the grating 2 is perpendicular to the side c or the side d, or is parallel to the side c or the side d, there are two diffracted light beams 5 of the incident light beam 4, and an angle between one diffracted light beam and the incident light beam is not equal to an angle between the other diffracted light beam and the incident light beam, that is, θ3 is not equal to θ4, and the components of the two diffracted light beams 5 in the plane of the grating 2 are no longer equal to each other. It should be noted here that when the incident light beam 4 is incident on the grating 2 at other angles, two diffracted light beams 5 will also be generated. For comparison, the incident direction of the incident light beam 4 is set to be vertical or parallel to the side c or side d. In this direction, the difference is more obvious compared to the grating A3 made of the cell arrays A31.

Referring to FIG. 5, in one embodiment, the grating 2 is a two-dimensional grating 2, and each of the cell arrays 21 comprises at least four lattice points 211, each of which has the same height, or at least two of which have different heights; when each of the lattice points 211 of each of the cell arrays 21 has the same height, the lattice points 211 of at least two of the cell arrays 21 have different heights.

In another embodiment, wherein each of the lattice points 211 has the same rotation angle, or at least two of the lattice points 211 have different rotation angles, and when each of the lattice points 211 of each of the cell arrays 21 has the same rotation angle, the lattice points 211 of at least two of the cell arrays 21 have different rotation angle.

In another embodiment, each of the lattice points 211 has the same twisting angle, or at least two of the lattice points 211 have different twisting angles, and when each of the lattice points 211 of each of the cell arrays 21 has the same twisting angle, the lattice points 211 of at least two of the cell arrays 21 have different twisting angles.

Specifically, as for the shapes and morphological features of the lattice points 211 in the cell arrays 21 of the present disclosure, the shapes may be arbitrary, and may be relatively complex polygons. The height, and twist and rotation angles of each lattice point 211 may be adjusted, and each of the lattice point 211 may be in the same state or in different state. As shown in FIGS. (5.1) and (5.2), each lattice point 211 in the cell array 21 has the same shape and angle, and may be a rectangle or a five-pointed star. As shown in FIG. (5.3), the heights of the lattice points 211 may be different, but their respective rotation angles are the same. As shown in FIG. (5.4), the heights of the lattice points 211 may be different and have their own twist angles. Of course, the height, rotation angle, or twist angle of each lattice point 211 in one cell array 21 of the grating 2 may be the same, and one of the heights, rotation angles, or twist angles of at least two cell arrays 21 are different. In the above embodiment, each height, each rotation angle or twist angle corresponds to a diffraction state. Therefore, the shape, height, size or angle of the lattice points 211 in the cell array 21 may be adjusted according to actual needs to meet different diffraction needs. Of course, the cell array 21 may also comprise five lattice points 211, and in addition to the four lattice points 211 located at the four vertices of the parallelogram, it may also comprise a lattice point 211 located at the center of the parallelogram.

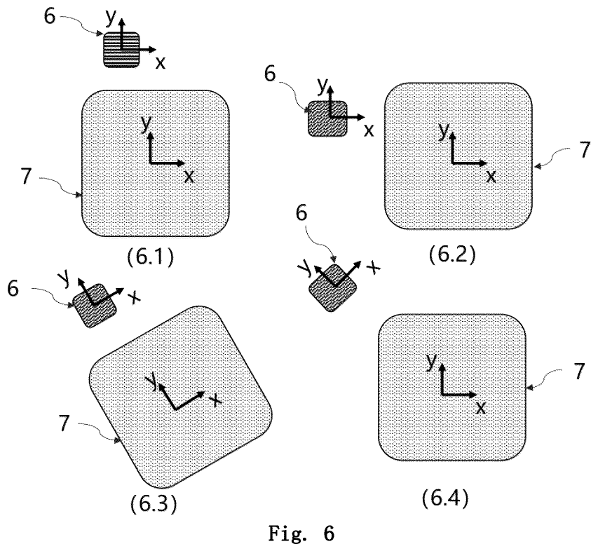

Referring to FIG. 6, in one embodiment, the grating 2 comprises an in-coupling grating 6 and an out-coupling grating 7, and the in-coupling grating 6 and the out-coupling grating 7 are asymmetrically disposed. Specifically, referring to FIG. (6.1) and FIG. (6.2), the in-coupling grating 6 is translated by a preset distance relative to the horizontal symmetry axis or the vertical symmetry axis of the out-coupling grating 7. Alternatively, referring to FIG. (6.3), the in-coupling grating 6 and the out-coupling grating 7 are synchronously rotated by the same angle. Alternatively, referring to FIG. (6.4), the in-coupling grating 6 is rotated relative to the out-coupling grating 7 by a first angle; or the out-coupling grating 7 is rotated relative to the in-coupling grating 6 by a second angle. The in-coupling grating 6 may be a one-dimensional grating or a two-dimensional grating, and the out-coupling grating 7 is generally a two-dimensional grating.

In the related art, the pupil expansion form of the grating A3 composed of the cell arrays A31 is generally mainly symmetrical. If the in-coupling grating 6 and the out-coupling grating 7 are not symmetrically disposed, it is easy to cause the light coupled out from the in-coupling grating 6 to fail to reach the out-coupling grating 7, which easily causes insufficient light intensity or incomplete image. Therefore, the grating A3 composed of the cell arrays A31 limits the form of the optical waveguide system. The pupil expansion form of the grating 2 composed of the cell arrays 21 may be mainly asymmetrical, which increases the pupil expansion form of the optical waveguide system. The above grating 2 may be used in the optical waveguide system in FIG. 4. Specifically, the in-coupling grating 6 and the out-coupling grating 7 may be combined in a relatively free arrangement form. The in-coupling grating 6 may be not on the symmetry axis of the out-coupling grating 7, but offset by a certain distance. This offset may be offset relative to the horizontal or vertical symmetry axis, and the grating vector of the in-coupling grating 6 may rotate to a certain extent with the offset. The in-coupling grating 6 and the out-coupling grating 7 may have a certain rotation, which rotates around a specific center. The in-coupling grating 6 and the out-coupling grating 7 may rotate synchronously or individually rotate at a certain angle. The relative position and grating vector of the in-coupling grating 6 and the out-coupling grating 7 may be changed according to actual needs, and the change comprises translation, bias and rotation. These operations may act on the grating 2 in the form of permutations and combinations. The above operations are more suitable for the grating 2 composed of the cell arrays 21. These operations increase the pupil expansion mode of the optical waveguide system, making the optical waveguide system more flexible to meet the needs of different appearances and application scenarios, while improving the performance of the optical waveguide system.

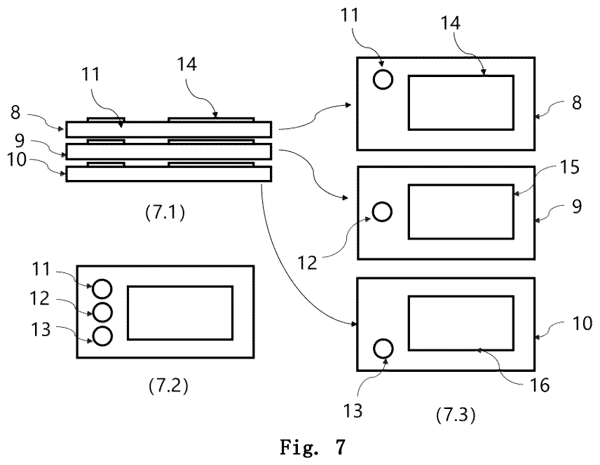

Referring to FIG. 7, in one embodiment, the optical waveguide 1 comprises a first optical waveguide 8, a second optical waveguide 9 and a third optical waveguide 10, which are stacked in sequence, and the grating comprises a first layer of grating disposed on the surface of the first optical waveguide 8, a second layer of grating disposed on the surface of the second optical waveguide 9 and a third layer of grating disposed on the surface of the third optical waveguide 10. The first optical waveguide 8, the second optical waveguide 9 and the third optical waveguide 10 have different filtering colors, and after the three waveguides are stacked, they output together to form a complete image.

Please refer to FIG. 7 again. In one embodiment, the first layer of grating comprises a first in-coupling grating 11 and a first out-coupling grating 14, the second layer of grating comprises a second in-coupling grating 12 and a second out-coupling grating 15, and the third layer of grating comprises a third in-coupling grating 13 and a third out-coupling grating 16. When viewed in a stacking direction of the first optical waveguide 8, the second optical waveguide 9 and the third optical waveguide 10, the first in-coupling grating 11, the second in-coupling grating 12 and the third in-coupling grating 13 are mutually staggered. It should be noted that the first in-coupling grating 11 and the first out-coupling grating 14 may be located on the same side of the first optical waveguide 8, or respectively on opposite sides of the first optical waveguide 8, and similarly, the second in-coupling grating 12 and the second out-coupling grating 15 may be located on the same side of the second optical waveguide 9, or respectively on opposite sides of the second optical waveguide 9; the third in-coupling grating 13 and the third out-coupling grating 16 may be located on the same side of the third optical waveguide 10, or respectively on opposite sides of the third optical waveguide 10. In this embodiment, the first in-coupling grating 11, the second in-coupling grating 12, and the third in-coupling grating 13 are mutually staggered, and the first out-coupling grating 14, the second out-coupling grating 15, and the third out-coupling grating 16 overlap in plane of the top view, and they output together to form a complete image. The staggered arrangement of the first in-coupling grating 11, the second in-coupling grating 12, and the third in-coupling grating 13 may reduce the loss of light of different wavelengths when passing through the coupling region multiple times, thereby improving the diffraction efficiency.

In a specific embodiment, the first optical waveguide 8 is a red-light waveguide, the second optical waveguide 9 is a green-light waveguide, and the third optical waveguide 10 is a blue-light waveguide. The optical waveguide system is a lens of an augmented reality device, which is composed of three optical waveguides, of which one transmits a red image, another one transmits a green image, and remaining one transmits a blue image. The first out-coupling grating 15 and the third out-coupling grating 16 of the red-light waveguide and the blue-light waveguide adopt grating 2, and the first in-coupling grating 11 and the third in-coupling grating 13 thereof have a certain offset; the second out-coupling grating 15 of the green-light waveguide may adopt the grating A3, and the second in-coupling grating 12 of the grating A3 is located on the symmetry axis of the second out-coupling grating 15. Of course, as long as the three in-coupling gratings are mutually staggered, the positions of the three optical waveguides may be arbitrarily exchanged.

In one embodiment, the optical waveguide 1 comprises a first optical waveguide 8 and a second optical waveguide 9, which are stacked in sequence, and the grating comprises a first layer of grating disposed on the surface of the first optical waveguide 8 and a second layer of grating disposed on the surface of the second optical waveguide 9; the first layer of grating comprises a first in-coupling grating 11 and a first out-coupling grating 14, and the second layer of grating comprises a second in-coupling grating 12 and a second out-coupling grating 15. When viewed in the stacking direction of the first optical waveguide 8 and the second optical waveguide 9, the first in-coupling grating 11 and the second in-coupling grating 12 are mutually staggered. The first optical waveguide 8 transmits one of the three color lights of red, green and blue, and the second optical waveguide 9 transmits the other two color lights except the color light transmitted by the first optical waveguide 8. Here, the first optical waveguide 8 may transmit red light, and the second optical waveguide 9 may transmit blue and green lights; or the first optical waveguide 8 may transmit green light, and the second optical waveguide 9 may transmit blue and red lights; or the first optical waveguide 8 may transmit blue light, and the second optical waveguide 9 may transmit green and red lights. The first out-coupling grating 14 and the second out-coupling grating 15 overlap in the plane of the top view and output together to form a complete image. The staggered arrangement of the first in-coupling grating 11 and the second in-coupling grating 12 may reduce the loss of light of different wavelengths when passing through the in-coupling region multiple times, thereby improving the diffraction efficiency.

According to another aspect of the present disclosure, the present disclosure further provides an augmented reality device, which comprises the above-mentioned optical waveguide system. Since the augmented reality device comprises all technical solutions of all embodiments of all the above-mentioned optical waveguide systems, it has at least all the beneficial effects brought by all the above-mentioned technical solutions, which will not be described one by one here.

The above are only optional embodiments of the present disclosure, and are not intended to limit the patent scope of the present disclosure. All equivalent structural changes made using the contents of the present disclosure's specification and drawings under the technical concept of the present disclosure, or directly/indirectly applied in other related technical fields, are included in the patent protection scope of the present disclosure.

1. An optical waveguide system, comprising:
an optical waveguide; and
a grating disposed on a surface of the optical waveguide,
wherein the grating comprises a plurality of cell arrays, and each of the cell arrays has a parallelogram shape, such that one incident light beam incident on the grating is diffracted into two diffracted light beams, and an angle between a component of one diffracted light beam on a plane of the grating and a component of the incident light beam on the plane of the grating is not equal to an angle between a component of the other diffracted light beam on the plane of the grating and the component of the incident light beam on the plane of the grating.

2. The optical waveguide system according to claim 1, wherein each of the cell arrays comprises a first grating vector and a second grating vector, the parallelogram shape comprises adjacent horizontal sides and vertical sides, the first grating vector corresponds to the horizontal sides, and the second grating vector corresponds to the vertical sides.

3. The optical waveguide system according to claim 2, wherein an angle between the first grating vector and the second grating vector is θ, and 0<θ<180°, and lengths of the horizontal sides are not equal to lengths of the vertical sides.

4. The optical waveguide system according to claim 2, wherein the grating is a two-dimensional grating, and each of the cell arrays comprises at least four lattice points, wherein each of the lattice points has the same height, or at least two of the lattice points have different heights, and
wherein when each of the lattice points of each of the cell arrays has the same height, the lattice points of at least two of the cell arrays have different heights.

5. The optical waveguide system according to claim 4, wherein each of the lattice points has the same rotation angle, or at least two of the lattice points have different rotation angles, and
wherein when each of the lattice points of each of the cell arrays has the same rotation angle, the lattice points of at least two of the cell arrays have different rotation angle.

6. The optical waveguide system according to claim 4, wherein each of the lattice points has the same twisting angle, or at least two of the lattice points have different twisting angles, and
wherein when each of the lattice points of each of the cell arrays has the same twisting angle, the lattice points of at least two of the cell arrays have different twisting angles.

7. The optical waveguide system according to claim 1, wherein the grating comprises an in-coupling grating and an out-coupling grating, and the in-coupling grating and the out-coupling grating are disposed asymmetrically.

8. The optical waveguide system according to claim 7, wherein the in-coupling grating is disposed to be translated by a preset distance relative to a horizontal symmetry axis or a vertical symmetry axis of the out-coupling grating.

9. The optical waveguide system according to claim 7, wherein the in-coupling grating and the out-coupling grating are synchronously rotated by the same angle.

10. The optical waveguide system according to claim 7, wherein the in-coupling grating is disposed to be rotated relative to the out-coupling grating by a first angle; or
the out-coupling grating is disposed to be rotated relative to the in-coupling grating by a second angle.

11. The optical waveguide system according to claim 1, wherein the optical waveguide comprises a first optical waveguide, a second optical waveguide and a third optical waveguide stacked in sequence, and the grating comprises a first layer of grating disposed on a surface of the first optical waveguide, a second layer of grating disposed on a surface of the second optical waveguide and a third layer of grating disposed on a surface of the third optical waveguide.

12. The optical waveguide system according to claim 11, wherein the first layer of grating comprises a first in-coupling grating and a first out-coupling grating, the second layer of grating comprises a second in-coupling grating and a second out-coupling grating, and the third layer of grating comprises a third in-coupling grating and a third out-coupling grating, and
when viewed in a stacking direction of the first optical waveguide, the second optical waveguide and the third optical waveguide, the first in-coupling grating, the second in-coupling grating and the third in-coupling grating are mutually staggered.

13. The optical waveguide system according to claim 12, wherein the first optical waveguide is a red-light waveguide, the second optical waveguide is a green-light waveguide, and the third optical waveguide is a blue-light waveguide.

14. The optical waveguide system according to claim 1, wherein the optical waveguide comprises a first optical waveguide and a second optical waveguide stacked in sequence, and the grating comprises a first layer of grating disposed on a surface of the first optical waveguide and a second layer of grating disposed on a surface of the second optical waveguide,
wherein the first layer of grating comprises a first in-coupling grating and a first out-coupling grating, the second layer of grating comprises a second in-coupling grating and a second out-coupling grating, and when viewed in a stacking direction of the first optical waveguide and the second optical waveguide, the first in-coupling grating and the second in-coupling grating are mutually staggered, and
wherein the first optical waveguide transmits one of three color lights of red light, green light and blue light, and the second optical waveguide transmits the other two color lights except the color light transmitted by the first optical waveguide.

15. An augmented reality device comprising the optical waveguide system according to claim 1.
